(19) United States
(12) Patent Application Publication
(10) Pub. No.: US 2023/0324317 A1
(43) Pub. Date: Oct. 12, 2023

(54) INSPECTION DEVICE AND INSPECTION METHOD

(71) Applicant: Kioxia Corporation, Tokyo (JP)

(72) Inventors: Takahiro IKEDA, Yokohama Kanagawa (JP); Takashi ICHIKAWA, Saitama Saitama (JP); Takaki HASHIMOTO, Yokohama Kanagawa (JP); Hiroyuki TANIZAKI, Nagoya Aichi (JP)

(73) Assignee: Kioxia Corporation, Tokyo (JP)

(21) Appl. No.: 17/939,145

(22) Filed: Sep. 7, 2022

(30) Foreign Application Priority Data
Mar. 22, 2022 (JP) 2022-045881

(51) Int. Cl. G01B 15/04; G01N 23/201

(52) U.S. Cl. CPC G01N 23/201; G01B 15/04; G01N 2223/054; G01N 2223/611

(57) ABSTRACT

According to one embodiment, there is provided an inspection device including a measurement unit and a controller. The measurement unit measures a physical quantity in accordance with a predetermined pattern for a sample with the predetermined pattern, and generates a first spectral pattern in accordance with a measurement result. The controller predicts a processed cross-sectional shape by applying a parameter to a shape function indicating an ion flux amount in accordance with an etching depth in a case where the predetermined pattern is processed in dry etching processing, determines a second spectral pattern in accordance with the processed cross-sectional shape that has been predicted, adjusts the parameter while comparing the first spectral pattern with the second spectral pattern, and reconstructs the processed cross-sectional shape of the sample in accordance with an adjustment result.

### CROSS-REFERENCE TO RELATED APPLICATIONS

This application is based upon and claims the benefit of priority from Japanese Patent Application No. 2022-045881, filed on Mar. 22, 2022; the entire contents of which are incorporated herein by reference.

### FIELD

Embodiments described herein relate generally to an inspection device and an inspection method.

### BACKGROUND

An inspection device measures a physical quantity in accordance with a predetermined pattern for a sample with the predetermined pattern, and may reconstruct a cross-sectional processed shape from a spectral pattern in accordance with the measurement result. The inspection device is desired to reconstruct the cross-sectional processed shape with high accuracy.

### BRIEF DESCRIPTION OF THE DRAWINGS

FIG. 1 illustrates the configuration of an inspection device according to an embodiment;

FIG. 2 illustrates the operation of a measurement unit in the embodiment;

FIG. 3 illustrates the operation of a controller in the embodiment;

FIG. 4 is a flowchart illustrating the operation of the inspection device according to the embodiment;

FIG. 5 illustrates dry etching processing in the embodiment;

FIG. 6 illustrates ion emission-directionality and a processed cross-sectional shape in the embodiment;

FIG. 7 illustrates a shape function in the embodiment;

FIG. 8 illustrates a change in a depth direction of the shape function in the embodiment;

FIG. 9 illustrates a prediction result of a processed cross-sectional shape based on an addition of plural shape functions in the embodiment;

FIG. 10 illustrates the correspondence between a processed cross-sectional shape and plural shape functions in the embodiment;

FIGS. 11A to 11C illustrate algebraic equations having a shape function in the embodiment as a solution;

FIG. 12 illustrates a temporal change of a coefficient in the embodiment;

FIGS. 13A to 13D illustrate temporal traces of processed cross-sectional shapes in the embodiment; and

FIG. 14 illustrates temporal changes in depth positions of a frontage portion, an upper stage of bowing portion, and a lower stage of bowing portion in the embodiment.

### DETAILED DESCRIPTION

In general, according to one embodiment, there is provided an inspection device including a measurement unit and a controller. The measurement unit measures a physical quantity in accordance with a predetermined pattern for a sample with the predetermined pattern, and generates a first spectral pattern in accordance with a measurement result. The controller predicts a processed cross-sectional shape by applying a parameter to a shape function indicating an ion flux amount in accordance with an etching depth in a case where the predetermined pattern is processed in dry etching processing, determines a second spectral pattern in accordance with the processed cross-sectional shape that has been predicted, adjusts the parameter while comparing the first spectral pattern with the second spectral pattern, and reconstructs the processed cross-sectional shape of the sample in accordance with an adjustment result.

Exemplary embodiments of an inspection device will be explained below in detail with reference to the accompanying drawings. The present invention is not limited to the following embodiments.

### Embodiment

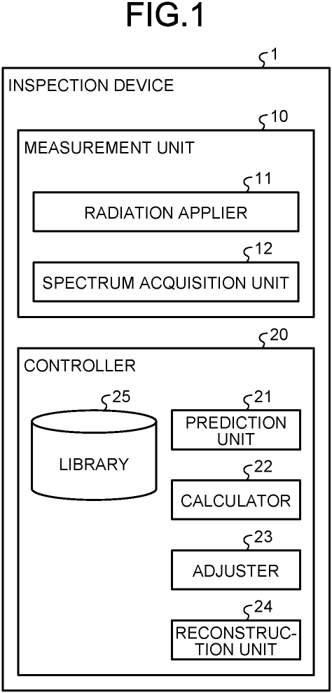

The inspection device according to the embodiment is used for obtaining a cross-sectional processed shape of a predetermined pattern without destruction, and is, for example, a transmission small angle X-ray scattering (T-SAXS) device. The inspection device measures a physical quantity in accordance with a predetermined pattern for a sample with the predetermined pattern, and reconstructs a cross-sectional processed shape in accordance with a spectral pattern in accordance with the measurement result and a calculated spectral pattern. An inspection device 1 can be configured as illustrated in FIG. 1. FIG. 1 illustrates the configuration of the inspection device 1.

The inspection device 1 includes a measurement unit 10 and a controller 20. The measurement unit 10 measures a physical quantity in accordance with a predetermined pattern for a sample SP with the predetermined pattern. The predetermined pattern is, for example, a fine (e.g., nanometer level of) hole pattern. The fine hole pattern has a high aspect ratio structure. Light hardly reach a bottom, and optically measuring the fine hole pattern is difficult. For that reason, the measurement unit 10 measures radiation diffracted by the sample SP at the time when the radiation (e.g., X-ray) is applied to the sample SP. The measurement unit 10 generates a spectral pattern PT1 in accordance with the measurement result.

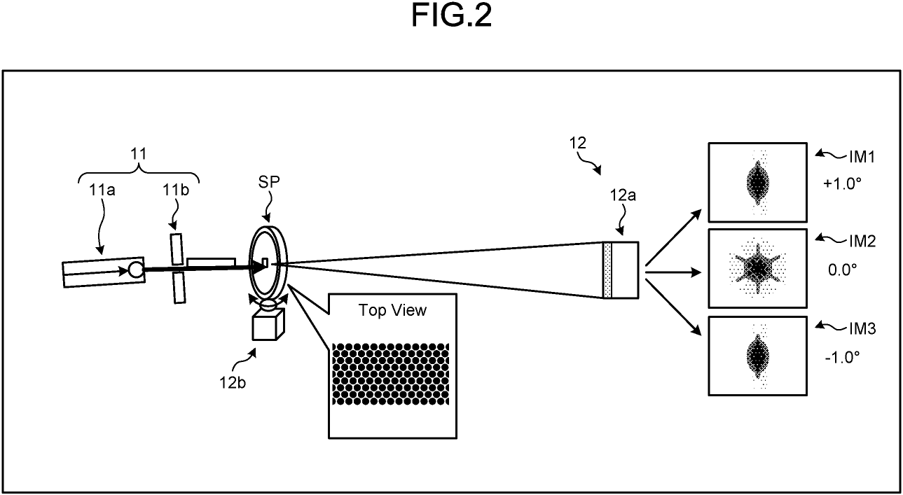

The measurement unit 10 includes a radiation applier 11 and a spectrum acquisition unit 12. The radiation applier 11 applies radiation to the sample SP. As illustrated in FIG. 2, the radiation applier 11 includes a radiation source 11a and a radiation optical system 11b, and the spectrum acquisition unit 12 includes a radiation detector 12a and a positioning mechanism 12b. FIG. 2 illustrates the operation of the measurement unit 10.

The radiation source 11a generates radiation, and emits a radiation beam. The radiation source 11a is, for example, an X-ray source. The X-ray source can include, for example, a particle accelerator radiation source, a liquid positive radiation source, a turning positive radiation source, a stationary solid positive radiation source, a micro focal radiation source, a micro focal turning positive radiation source, and an inverse Compton radiation source.

The radiation optical system 11b shapes the radiation beam emitted from the radiation source 11a, and guides the radiation beam to the sample SP. The radiation optical system 11b is, for example, an X-ray optical system. The radiation optical system 11b may collimate the radiation beam, or may focus the radiation beam near the sample SP.

The positioning mechanism 12b rotatably supports the sample SP. The sample SP is, for example, a substrate with a predetermined pattern. The radiation beam incident on the sample SP is diffracted in a predetermined pattern (e.g., fine hole pattern) in the sample SP.

The radiation detector 12a collects radiation scattered from the sample SP. The radiation detector 12a is, for example, an X-ray detector. The radiation detector 12a has plural two-dimensionally arranged pixels, and can acquire a two-dimensional intensity distribution of radiation.

In the sample SP, for example, fine hole patterns are periodically arranged with a predetermined spatial period. The spectrum acquisition unit 12 measures the radiation diffracted by the sample SP, and acquires the spectral pattern PT1 in accordance with the measurement result. The spectral pattern PT1 includes not only information on periodicity of arrangement of the fine hole patterns but information on a three-dimensional structure of the hole patterns. When the three-dimensional structures of the hole patterns are different, the spectral pattern PT1 is also different accordingly. The spectral pattern PT1 is, for example, an X-ray scattering pattern.

The spectrum acquisition unit 12 determines the position and direction of the sample SP with the positioning mechanism 12b while collecting scattered radiation with the radiation detector 12a. The spectrum acquisition unit 12 can thereby acquire an image indicating an angle-resolved scattered X-ray intensity as the spectral pattern PT1. For example, FIG. 2 illustrates an example in which images IM1, IM2, and IM3 are acquired as the spectral pattern PT1 for +1.0°, 0.0°, and - 1.0° for inclination angles to an optical axis of radiation of the sample SP, respectively.

The measurement unit 10 supplies the spectral pattern PT1 acquired by the spectrum acquisition unit 12 to the controller 20.

The controller 20 reconstructs a processed cross-sectional shape from the spectral pattern PT1 (e.g., X-ray scattering pattern) on a library basis. The processed cross-sectional shape will also be referred to as a processed cross-sectional profile. The library includes a shape function.

The shape function expresses the processed cross-sectional shape (processed cross-sectional profile) based on a physical model. As a result, it is possible to more faithfully express a processed cross-sectional shape so that the shape gets closer to an actual shape than in a case of using an ordinary polynomial. The shape function indicates an ion flux amount in accordance with an etching depth at the time when a predetermined pattern (e.g., fine hole pattern) is processed in dry etching processing. In a case of an axisymmetric hole pattern, the shape function indicates a cross-sectional shape of a side surface on one side with respect to the axis of the hole pattern. When the predetermined pattern (e.g., fine hole pattern) can be regarded as having an approximately axisymmetric shape, the three-dimensional shape of the predetermined pattern (e.g., fine hole pattern) is obtained by rotating a curve represented by the shape function around a depth-direction axis.

The shape function is obtained by integrating the amount of ion fluxes incident on a sidewall of the hole pattern in accordance with an etching depth in a depth direction. The ion flux amount includes ion incident angle distribution based on a velocity distribution function. When a divergence angle of ions emitted from an ion generation place is defined as θ and a parameter indicating the degree of divergence of ions is defined as n, the ion flux amount includes cosⁿ⁺²θ. The shape function is a solution of an algebraic equation including, in order, a parameter indicating the degree of divergence of ions.

The shape function further indicates a change in shape in accordance with an etching time. The shape function further includes a coefficient depending on the etching time. The coefficient includes an amount obtained by multiplying an etching rate by time. That is, since the shape function is a shape expression based on a mechanism of dry etching processing, shape expression including time evolution is possible. Clear relation between parameter variation and a state at the time of processing allows estimation of how much which parameter is to be changed at the time of changing a process condition, which facilitates parameter determination. Furthermore, there is a possibility that a change of a process condition mainly related to ion emission-directionality can be detected from a change of a parameter value after fitting.

This allows temporal trace of a processed cross-sectional shape without destruction. The temporal trace takes a lot of time in process development. The same or similar parameter can be diverted to confirm temporal change in cross-sectional processed shape. Therefore, development turn around time (TAT) of temporal trace of a processed cross-sectional shape can be significantly improved.

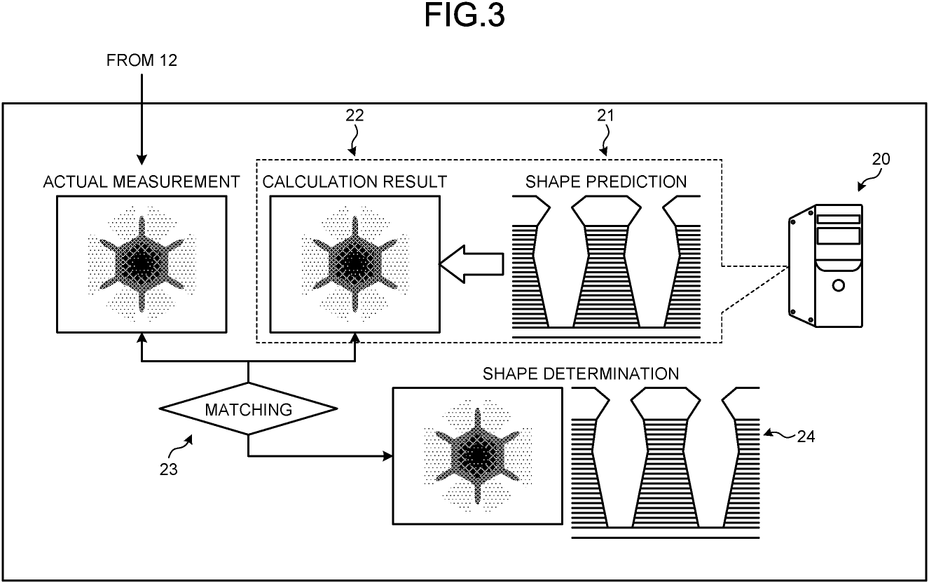

The controller 20 includes a prediction unit 21, a calculator 22, an adjuster 23, a reconstruction unit 24, and a library 25. The prediction unit 21 acquires a shape function with reference to the library 25. As illustrated in FIG. 3, the prediction unit 21 predicts a processed cross-sectional shape by applying a parameter to the shape function. FIG. 3 illustrates the operation of the controller 20. The calculator 22 determines a spectral pattern PT2 in accordance with the predicted processed cross-sectional shape. The calculator 22 calculates and determines a scattering pattern in a case where the predicted processed cross-sectional shape is diffracted by radiation (e.g., X-ray) by simulation.

The adjuster 23 acquires the spectral pattern PT1 from the spectrum acquisition unit 12, and acquires the spectral pattern PT2 from the calculator 22. The spectral pattern PT1 is actually measured by the measurement unit 10 (actually measured pattern). The spectral pattern PT2 is calculated by the calculator 22 (calculated result). The adjuster 23 adjusts (matches) parameters while comparing the spectral pattern PT1 with the spectral pattern PT2. The adjuster 23 compares the spectral pattern PT1 with the spectral pattern PT2. When the degree of coincidence between both is lower than a threshold, the adjuster 23 changes the parameters, and supplies the parameters to the prediction unit 21.

The prediction unit 21 predicts a processed cross-sectional shape by applying the changed parameters to the shape function. The calculator 22 determines a spectral pattern PT2 in accordance with the predicted processed cross-sectional shape. The adjuster 23 compares the spectral pattern PT1 with the spectral pattern PT2. When the degree of coincidence between both is equal to or greater than a threshold, the adjuster 23 notifies the reconstruction unit 24 that both coincide with each other.

The reconstruction unit 24 reconstructs the processed cross-sectional shape of the sample in accordance with the adjustment result of the adjuster 23. That is, the reconstruction unit 24 acquires the processed cross-sectional shape from the prediction unit 21 in response to the notification that the spectral pattern PT1 and the spectral pattern PT2 coincide with each other from the adjuster 23. The reconstruction unit 24 determines the acquired processed cross-sectional shape as the processed cross-sectional shape of the sample (shape determination).

That is, since the processed cross-sectional shape is reconstructed by using a shape function that more faithfully expresses the processed cross-sectional shape close to an actual shape while causing the spectral pattern PT1 and the spectral pattern PT2 to coincide with each other, robustness of inspection performed by the inspection device 1 can be improved.

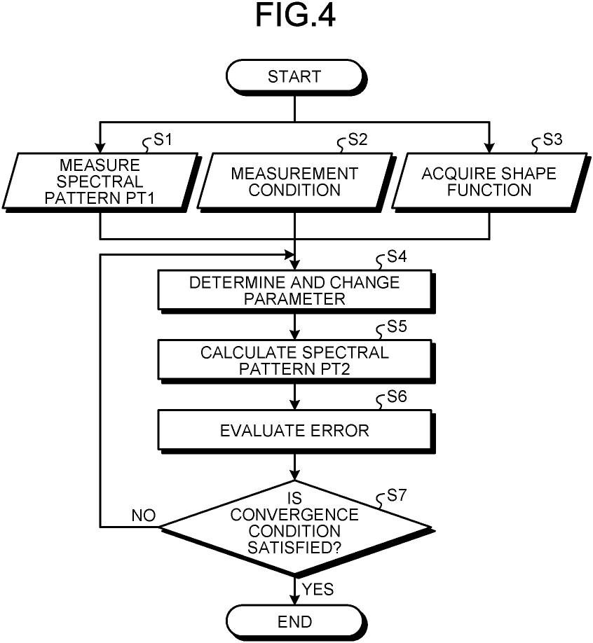

Next, the operation of the inspection device 1 will be described with reference to FIG. 4. FIG. 4 is a flowchart illustrating the operation of the inspection device.

The inspection device 1 acquires the spectral pattern PT1 by measurement (S1). The inspection device 1 applies radiation (e.g., X-ray) to the sample SP with a predetermined pattern (e.g., fine hole pattern), and detects radiation diffracted in the predetermined pattern. The inspection device 1 generates the spectral pattern PT1 (e.g., actual SAXS image) in accordance with the detected radiation. Furthermore, the inspection device 1 identifies a measurement condition used for measurement (S2). The measurement condition includes an inclination angle of the sample SP in the measurement.

In parallel, the inspection device 1 acquires a shape function with reference to the library 25 (S3). The shape function indicates an ion flux amount in accordance with an etching depth at the time when a predetermined pattern (e.g., fine hole pattern) is processed in dry etching processing.

The inspection device 1 adjusts a parameter by executing loop processing of S4 to S7 by using the spectral pattern SP1 measured in S1, the measurement condition acquired in S2, and the shape function acquired in S3.

For example, the inspection device 1 determines a parameter in accordance with the spectral pattern SP1 and the measurement condition (S4), and applies the parameter to the shape function to predict the cross-sectional processed shape. The inspection device 1 determines the spectral pattern PT2 by calculation in accordance with the predicted cross-sectional processed shape (S5). The inspection device 1 compares the spectral pattern PT1 measured in S1 with the spectral pattern PT2 calculated in S5, evaluates an error (S6), and determines whether or not the evaluation result satisfies a convergence condition of the loop processing of S4 to S7 (S7).

When the degree of coincidence between the spectral pattern PT1 and the spectral pattern PT2 is lower than a threshold (No in S7), the inspection device 1 changes the parameter (S4), and applies the changed parameter to the shape function to predict the processed cross-sectional shape. The inspection device 1 determines the spectral pattern PT2 by calculation again in accordance with the predicted processed cross-sectional shape (S5). The inspection device 1 compares the spectral pattern PT1 measured in S1 with the spectral pattern PT2 calculated in S5, evaluates an error (S6), and determines whether or not the evaluation result satisfies a convergence condition of the loop processing of S4 to S7 (S7). That is, the inspection device 1 repeats the loop processing of S4 to S7 until the degree of coincidence between the spectral pattern PT1 and the spectral pattern PT2 becomes equal to or greater than the threshold (Yes in S7).

When the degree of coincidence between the spectral pattern PT1 and the spectral pattern PT2 becomes equal to or greater than the threshold (Yes in S7), the inspection device 1 determines that the cross-sectional processed shape predicted in S4 corresponds to the actually measured spectral pattern PT1, and ends the processing. This allows the processed cross-sectional shape of the sample SP to be reconstructed. The reconstructed processed cross-sectional shape can be applied to, for example, evaluating the appropriateness of a process condition.

Next, the shape function will be described. The shape function indicates an ion flux amount in accordance with an etching depth at the time when a predetermined pattern is processed in dry etching processing.

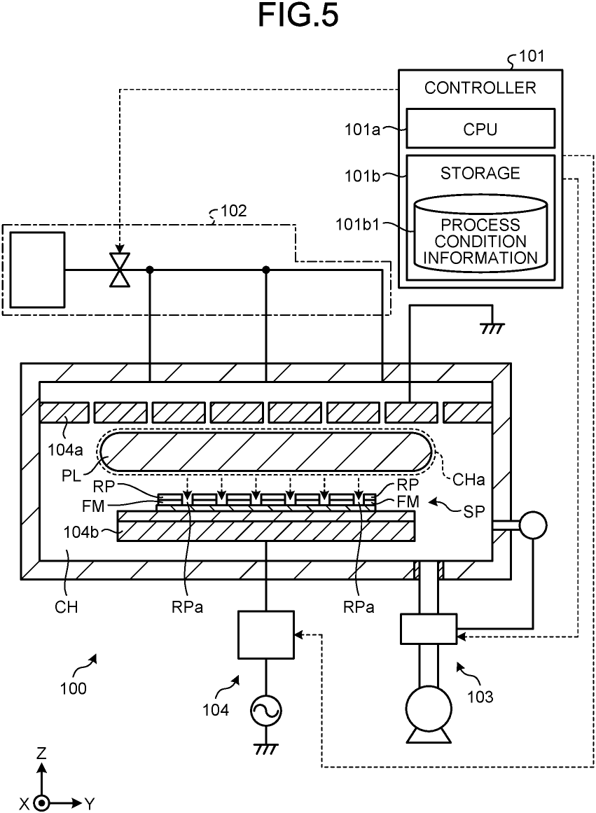

The dry etching processing is performed by a plasma processing device 100 as illustrated in FIG. 5. FIG. 5 illustrates the dry etching processing. In FIG. 5, a direction perpendicular to the surface of the sample SP is defined as a Z direction, and two directions orthogonal to each other in a plane perpendicular to the Z direction are defined as an X direction and a Y direction.

The sample SP is placed on a lower electrode 104b in a processing chamber CH. A resist pattern RP having a fine hole pattern RPa is formed on the surface of the sample SP. A controller 101 includes a CPU 101a and a storage 101b. The storage 101b stores process condition information 101b1. The controller 101 controls a gas supply system 102 and an exhaust system 103 and adjusts a processing gas amount in the processing chamber CH in accordance with the process condition information 101b1. The controller 101 controls a power supply 104 and forms an electric field between an upper electrode 104a and the lower electrode 104b in the processing chamber CH in accordance with the process condition information 101b1. This generates plasma PL of processing gas in space CHa, which is separated on the side of +Z from the lower electrode 104b in the processing chamber CH, and ionizes the processing gas. Furthermore, as indicated by a dotted line of arrow, an ion (reactive ion) of the processing gas is accelerated to the side of a workpiece film FM on the sample SP (e.g., substrate) by an electric field in the -Z direction. An ion is applied to the sample SP by using the resist pattern RP as an etching mask, so that etching processing of a hole pattern 200 corresponding to the hole pattern RPa is performed on the workpiece film FM, for example.

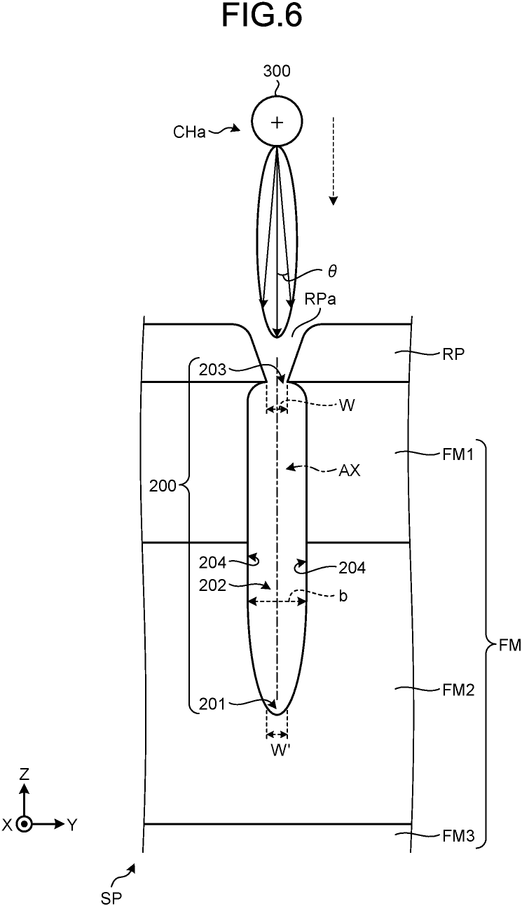

The shape function is a shape expression based on a mechanism of dry etching processing. In the dry etching processing, as illustrated in FIG. 6, an ion 300 is accelerated from the generation place (space CHa) to the workpiece film FM on the sample SP in the -Z direction with a certain degree of divergence angle. FIG. 6 is a YZ cross-sectional view illustrating ion emission-directionality and a processed cross-sectional shape.

For example, when the processing gas is in an ideal thermal equilibrium state, the distribution of a velocity vector of the ion 300 that moves from the generation place toward the sample SP can be approximated by a Maxwell velocity distribution function. Thus, when the divergence angle is defined as θ, the flux of the ions 300 that move from the generation place toward the sample SP has an amount depending on an angular distribution function f(θ). The angular distribution function f(θ) indicates the angular distribution of velocity vectors of the ions in accordance with the Maxwell velocity distribution function.

When a parameter indicating the degree of divergence (i.e., emission-directionality) of the ion 300 is defined as n, the flux of the ions that move from the generation place (space CHa) toward the sample SP has an amount depending on the angular distribution function f(θ) = cosⁿθ. The parameter n indicates the directivity of the angular distribution of the ions. The parameter n has a larger value as the electric field acting on the ions is stronger (i.e., as anisotropy of etching is larger). The larger parameter n indicates a higher emission-directionality of an ion.

The hole pattern 200 as illustrated in FIG. 6 is formed on the workpiece film FM by ion application. For the sake of simplicity, FIG. 6 illustrates a processed cross-sectional shape of one hole pattern 200. The processed cross-sectional shape of the hole pattern 200 is approximated by an axisymmetric cross-sectional shape. An axis AX of the hole pattern 200 is substantially parallel to the direction of the electric field as indicated by an alternate long and short dash line in FIG. 6. The hole pattern 200 is formed by etching the workpiece film FM by using the hole pattern RPa of the resist pattern RP as an etching mask. In the workpiece film FM, a film FM2 and a film FM1 are stacked. The hole pattern 200 penetrates the film FM1, and reaches the middle of the film FM2. The hole pattern 200 may penetrate the film FM1, further penetrate the film FM2, and reach a film FM3. The film FM1 is, for example, an insulating film, and can be formed of a material containing an oxide such as silicon oxide as a main component. The film FM2 is, for example, an insulating film, and can be formed of a material containing a nitride such as silicon nitride as a main component. The film FM3 is, for example, a conductive film. The film FM3 may be formed of a material containing a semiconductor with conductivity as a main component, or may be formed of a material containing metal such as tungsten, copper, and aluminum as a main component.

The hole pattern 200 may have a bowing shape extending in the Z direction in YZ cross-sectional view including the axis AX and having a diameter widened at a predetermined Z position between a +Z side end and a -Z side end. The hole pattern 200 includes a bottom 201, a bowing portion 202, and a frontage portion 203. The bottom 201 is located at the -Z side end of the hole pattern 200, and closes the hole pattern 200. The frontage portion 203 is located at the +Z side end of the hole pattern 200, and opens the hole pattern 200 on the +Z side. The bowing portion 202 is located between the bottom 201 and the frontage portion 203 in the Z direction, and has a relatively large XY plane width. The bowing portion 202 has a relatively large XY maximum distance of a sidewall 204 of the hole pattern 200.

When the XY plane width of the frontage portion 203 is defined as a frontage diameter w, the XY plane width of the bowing portion 202 is defined as a bow width b, and the XY plane width of the bottom 201 is defined as a bottom width w′, these satisfy the relations of Expressions 1 and 2 below.

$$b > w \qquad \text{Expression 1}$$

$$b > {w}^{′} \qquad \text{Expression 2}$$

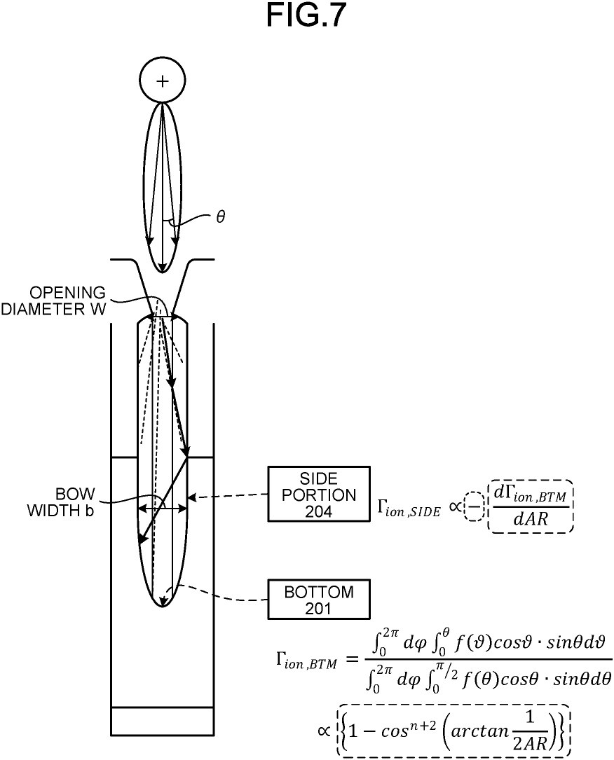

For example, the hole pattern 200 is formed on the workpiece film FM by ion application, and a flux of ions contributing to etching is referred to as an ion flux. In formulating the ion flux, as illustrated in FIG. 7, an ion flux forming the bottom 201 and an ion flux forming the sidewall 204 will be considered separately. An amount of an ion flux obtained by normalizing the ion flux forming the bottom 201 with all the ion fluxes applied from the ion generation place is referred to as an ion flux amount of the bottom, and is represented by Γ_{ion,BTM}. An amount of an ion flux obtained by normalizing the ion flux forming the sidewall 204 with all the ion fluxes applied from the ion generation place is referred to as an ion flux amount of the sidewall, and is represented by Γ_{ion,SIDE}. A volume of ions is determined by integrating a product of a component cosθ parallel to the axis AX of the velocity vector of an ion and a component sinθ perpendicular to the axis AX by a divergence angle θ and an angle φ around the axis AX. The number of the ions in the volume is determined by multiplying the volume by the angular distribution function f(θ). When the number of the ions is standardized by the number of ions in a case of a divergence angle of 90° (= π/2), the ion flux amount Γ_{ion,BTM} of the bottom 201 can be expressed by Expression 3 below.

$${\text{T}}_{i o n , B T M} = \frac{{\int }_{0}^{2 π} d φ {\int }_{0}^{θ} f \left(ϑ\right) cos ϑ ⋅ s i n θ d ϑ}{{\int }_{0}^{2 π} d φ {\int }_{0}^{\frac{π}{2}} f \left(θ\right) c o s θ ⋅ s i n θ d θ} \qquad \text{Expression 3}$$

An aspect ratio AR is defined as a parameter representing a depth position from the frontage portion 203 in the hole pattern 200. When a depth of a depth position of interest from the frontage portion 203 is defined as D and a frontage diameter is defined as w, the aspect ratio AR is determined as illustrated in Expression 4.

$$A R = D / w \qquad \text{Expression 4}$$

The ion flux amount I_{ion,BTM} of the bottom 201 is determined as a proportion of ions that have reached the bottom 201 without diverging from the frontage portion 203 to the sidewall 204. An angle θ from the frontage portion 203 to the bottom 201 is given by Expression 5 below.

$$θ = a r c t a n \frac{1}{2 A R} \qquad \text{Expression 5}$$

A proportion of ions diverging from the frontage portion 203 to the sidewall 204 is given by an angular distribution function of Expression 6 below.

$$f \left(θ\right) = {cos}^{n} θ \qquad \text{Expression 6}$$

When Expressions 4 to 6 are substituted into Expression 3 and integration is executed, the ion flux amount Γ_{ion,BTM} of the bottom 201 depends on cosⁿ⁺²θ as illustrated in Expression 7 below.

$${\text{T}}_{i o n , B T M} \left(A R ; n\right) = 1 - {cos}^{n + 2} \left(a r c t a n \left(\frac{1}{2 A R}\right)\right) \qquad \text{Expression 7}$$

The ion flux amount Γ_{ion,SIDE} of the sidewall 204 is determined as a proportion of ions that have diverged from the frontage portion 203 to the sidewall 204 and reached the sidewall 204. Since this relates to an amount of ions that reaches the side of the bottom 201 in accordance with the depth position, this depends on a value obtained by differentiating the ion flux amount Γ_{ion,BTM} of the bottom 201 by the aspect ratio AR as illustrated in Expression 8 below.

$${\text{T}}_{i o n , S I D E} \left(A R ; n\right) = C \left(t\right) ⋅ \frac{d {\text{T}}_{i o n , B T M}}{d A R} \qquad \text{Expression 8}$$

In Expression 8, C(t) is a coefficient depending on an etching time t. To simplify the expression, in Expression 7, when AR = x and

$$a r c t e n \left(\frac{1}{2 x}\right) = y$$

are set,

$$\frac{1}{2 x} = t a n y$$

and

$$c o s y = \frac{2 x}{\sqrt{4 {x}^{2} + 1}}$$

are established.

Consequently, the ion flux amount Γ_{ion,BTM} of the bottom 201 is represented by using x as in Expression 9 below.

$${\text{T}}_{i o n , B T M} \left(x ; n\right) \begin{matrix}= 1 - c o {s}^{n + 2} y \\ = 1 - {\left(\frac{2 x}{\sqrt{4 {x}^{2} + 1}}\right)}^{n + 2}\end{matrix} \qquad \text{Expression 9}$$

When Expression 9 is substituted into Expression 8 and differentiation is executed, the ion flux amount Γ_{ion,SIDE} of the sidewall 204 is represented by using x as in Expression 10 below.

$${\text{T}}_{i o n , S I D E} \left(x ; n ; t\right) \begin{matrix}= C \left(t\right) ⋅ \frac{d {\text{T}}_{i o n , B T M}}{d x} \\ = C \left(t\right) \left\{{2}^{n + 2} \left(n + 2\right) {x}^{n + 1} {\left(4 {x}^{2} + 1\right)}^{- \left(\frac{n}{2} + 2\right)}\right\}\end{matrix} \qquad \text{Expression 10}$$

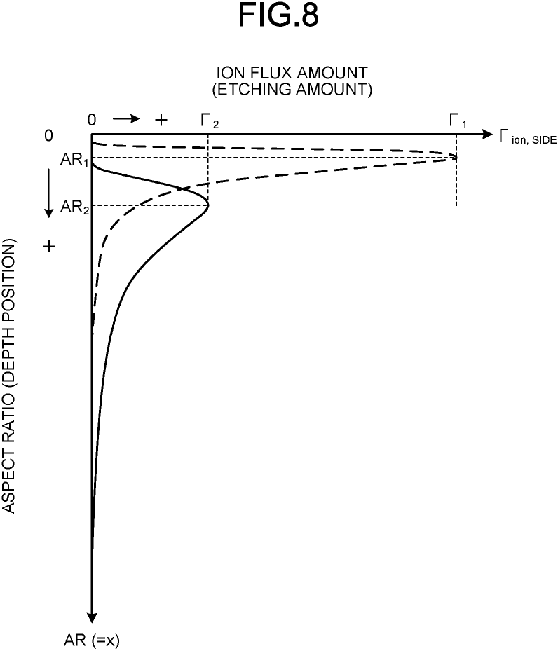

For example, when a graph is created by substituting n = n₁ and t = t₁ into Expression 10, using x = AR as a vertical axis, and using the ion flux amount Γ_{ion,SIDE} as a horizontal axis, the graph is indicated by a dotted line in FIG. 8 in a case where ions are incident with a degree of divergence. When the ion flux amount represents an etching amount as it is, the shape indicated by the dotted line in FIG. 8 approximately represents the processed cross-sectional shape during an etching time t₁ in the case where the ion emission-directionality is n₁. That is, FIG. 8 illustrates a prediction result of the processed cross-sectional shape.

Furthermore, when a graph is created by substituting n = n₂ (> n₁) and t = t₁ into Expression 10, using x = AR as a vertical axis, and using the ion flux amount Γ_{ion,SIDE} as a horizontal axis, the graph is indicated by a solid line in FIG. 8 in a case where ions are incident with a degree of directivity. When the ion flux amount represents an etching amount as it is, the shape indicated by the solid line in FIG. 8 approximately represents the processed cross-sectional shape during an etching time t₁ in the case where the ion emission-directionality is n₂.

Compared with the processed cross-sectional shape indicated by the dotted line, the processed cross-sectional shape indicated by the solid line corresponds to a larger value of n. As illustrated in FIG. 8, the bowing portion 202 having the processed cross-sectional shape indicated by the solid line has a broader shape in the x direction than the bowing portion 202 having the processed cross-sectional shape indicated by the dotted line. An x position (aspect ratio AR₂) of the bowing portion 202 having the processed cross-sectional shape indicated by the solid line is deeper than an x position (aspect ratio AR₁) of the bowing portion 202 having the processed cross-sectional shape indicated by the dotted line. A peak value (peak ion flux amount Γ₂) of the bowing portion 202 having the processed cross-sectional shape indicated by the solid line is smaller than a peak value (peak ion flux amount Γ₁) of the bowing portion 202 having the processed cross-sectional shape indicated by the dotted line.

That is, as n is larger and the ion emission-directionality is higher, the bowing portion 202 of the hole pattern 200 tends to be wider and successfully located at a deeper position. This seems to be consistent with the behavior of ion divergence.

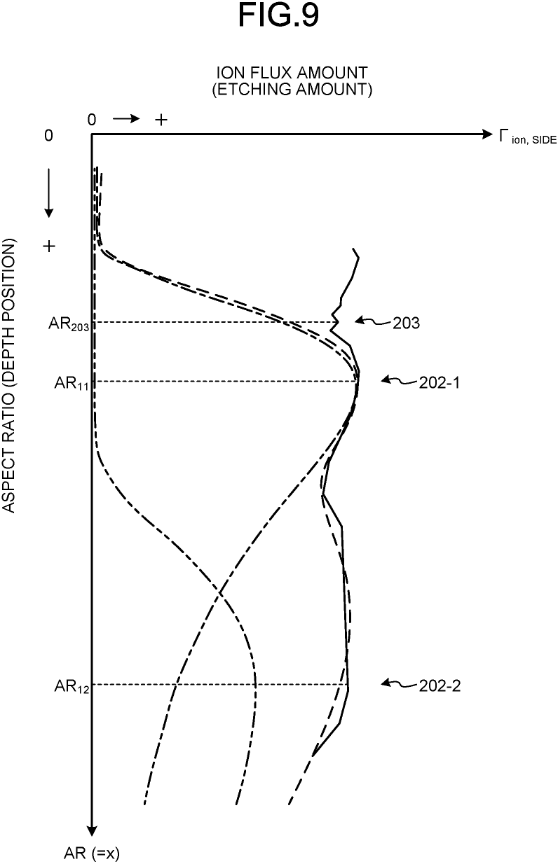

In dry etching processing, the processed cross-sectional shape may be formed so as to include two stages of bowing portions 202-1 and 202-2 in the depth direction as indicated by a solid line in FIG. 9. This is considered to be because plural ions having different directivities contributes to etching. In this case, an etching amount of the dry etching processing is considered to include ion incident angle distribution based on an addition of plural different velocity distribution functions. That is, as illustrated in FIG. 9, the processed cross-sectional shape can be represented based on the addition of plural shape functions. FIG. 9 illustrates a prediction result of a processed cross-sectional shape based on the addition of plural shape functions.

For example, when a graph is created by substituting n = n₁₁ and t = t₁₁ into Expression 10, using x = AR as a vertical axis, and using the ion flux amount Γ_{ion,SIDE} as a horizontal axis, the graph is indicated by an alternate long and short dash line in FIG. 9 in a case where a first ion is incident with a relatively low directivity. When the ion flux amount represents an etching amount as it is, the shape function indicated by the alternate long and short dash line in FIG. 9 approximately represents an ion flux amount during an etching time t₁₁ of the first ion having an emission-directionality of n₁₁.

Furthermore, when a graph is created by substituting n = n₁₂ (> n₁₁) and t = t₁₁ into Expression 10, using x = AR as a vertical axis, and using the ion flux amount Γ_{ion,SIDE} as a horizontal axis, the graph is indicated by an alternate long and two short dashes line in FIG. 9 in a case where a second ion is incident with a relatively high directivity. When the ion flux amount represents an etching amount as it is, the shape function indicated by the alternate long and two short dashes line in FIG. 9 approximately represents an ion flux amount during the etching time t₁₁ of the second ion having a emission-directionality of n₁₂.

When the shape function indicated by the alternate long and short dash line in FIG. 9 and the shape function indicated by the alternate long and two short dashes line in FIG. 9 are overlapped with each other, the processed cross-sectional shape indicated by the dotted line in FIG. 9 is approximately obtained. The processed cross-sectional shape indicated by the dotted line fits well to a result of performing cross-sectional SEM observation on the actual processed cross section indicated by the solid line in FIG. 9 in a region deeper than the depth position (aspect ratio AR₂₀₃) of the frontage portion 203. In FIG. 9, the depth position of the upper stage of bowing portion 202-1 is indicated by an aspect ratio AR₁₁, and the depth position of the lower stage of bowing portion 202-2 is indicated by an aspect ratio AR₁₂. The depth position (aspect ratio AR₁₁) of the upper stage of bowing portion 202-1 corresponds to the depth position in a case where the ion flux amount in the shape function of the alternate long and short dash line is at a peak. The depth position (aspect ratio AR₁₂) of the lower stage of bowing portion 202-2 corresponds to the depth position in a case where the ion flux amount in the shape function of the alternate long and two short dashes line is at a peak. That is, it is confirmed that, among the two stages of bowing portions 202-1 and 202-1, the upper stage of bowing portion 202-1 is formed mainly by etching of the first ion, and the lower stage of bowing portion 202-2 is formed mainly by etching of the second ion.

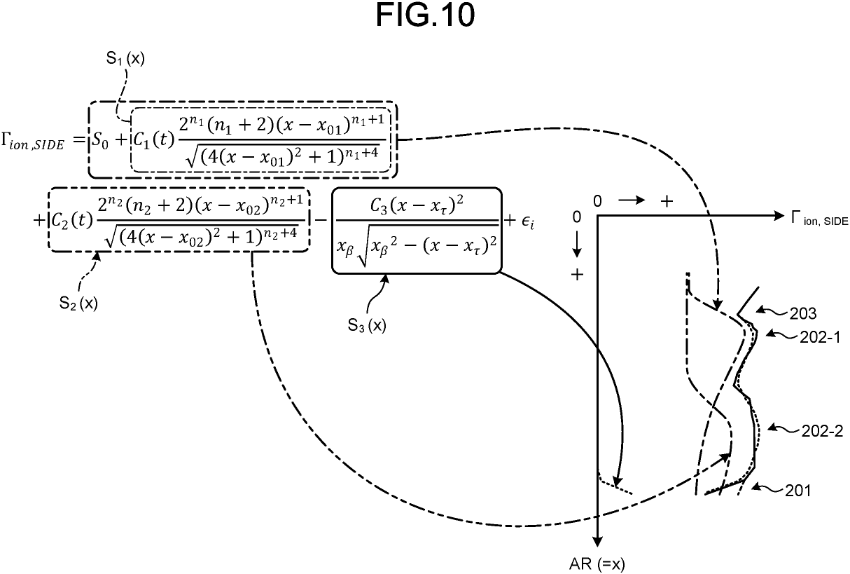

As illustrated in FIG. 10, the processed cross-sectional shape based on an addition of plural shape functions are obtained as the addition of the plural shape functions. FIG. 10 illustrates the correspondence between a processed cross-sectional shape and plural shape functions. As illustrated in FIG. 10, the ion flux amount Γ_{ion,SIDE} of the sidewall 204 is illustrated in Expression 11 below.

$${\text{T}}_{\text{ion,SIDE}} = {\text{S}}_{0} + {\text{S}}_{1} \left(\text{x}\right) + {\text{S}}_{2} \left(\text{x}\right) - {\text{S}}_{3} \left(\text{x}\right) + {ε}_{\text{i}} \qquad \text{Expression 11}$$

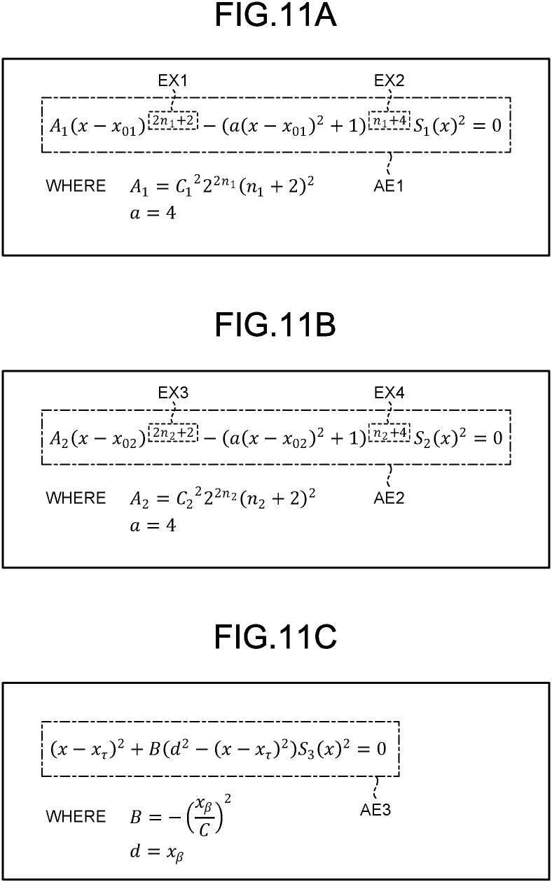

Expression 11 is a shape function based on the addition of plural shape functions, and may be referred to merely as an addition of shape functions. In Expression 11, the shape function “Sₒ + S1(x)” of the first and second items is the shape function of the first ion, corresponds to a graph of an alternate long and short dash line in the right figure of FIG. 10, and corresponds to the upper stage of bowing portion 202-1. A shape function S₀ of the first item has a constant value regardless of a depth parameter x. A shape function S₁(x) of the second item is a function of the depth parameter x, and obtained as a solution of an algebraic equation AE1 as illustrated in FIG. 11A. In the algebraic equation AE1, a parameter n₁ indicating the directivity of the first ion is used as orders EX1 and EX2. Order EX1 = 2n₁ + 2 and EX2 = n₁ + 4 are established. The algebraic equation AE1 supports a case where a thermal equilibrium state is established.

In Expression 11, a shape function S₂(x) of the third item is the shape function of the second ion, corresponds to a graph of an alternate long and two short dashes line in the right figure of FIG. 10, and corresponds to the lower stage of bowing portion 202-2. A shape function S₂(x) of the second item is a function of the depth parameter x, and obtained as a solution of an algebraic equation AE2 as illustrated in FIG. 11B. In the algebraic equation AE2, a parameter n₂ indicating the directivity of the second ion is used as orders EX3 and EX4. Order EX3 = 2n₂ + 2 and EX4 = n₂ + 4 are established. The algebraic equation AE2 supports a case where a thermal equilibrium state is established.

The shape function S₃(x) of the fourth item is a shape function of an ion that reaches a bottom surface, and corresponds to a graph of a dotted line with a narrow pitch in the right figure of FIG. 10. The shape function S₃(x) of the fourth item is a function of the depth parameter x, and obtained as a solution of an algebraic equation AE3 as illustrated in FIG. 11C.

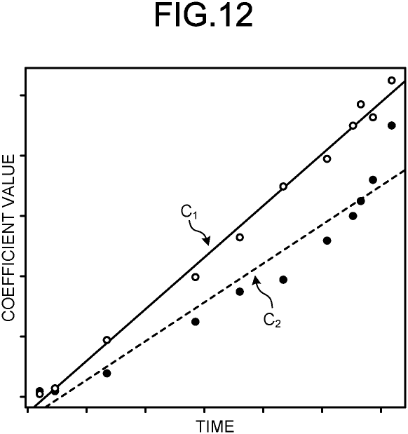

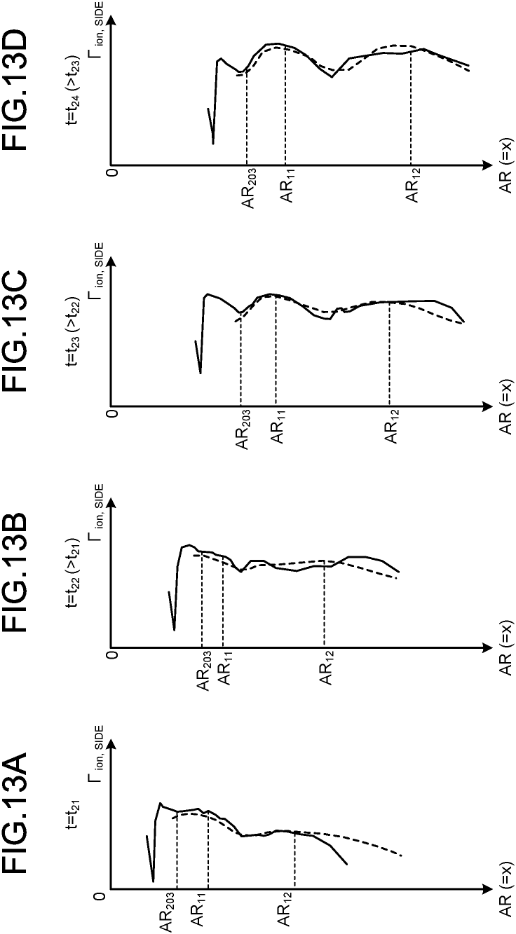

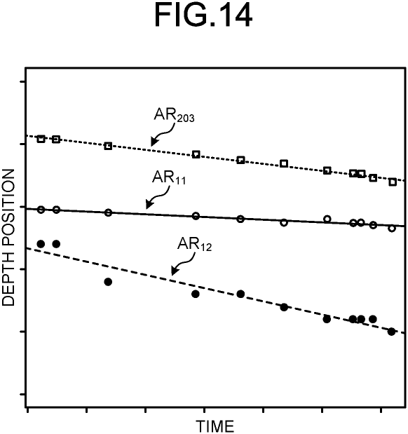

Next, a temporal trace of a processed cross-sectional shape by using a shape function will be described with reference to FIGS. 10 and 12 to 14. FIG. 12 illustrates a temporal change of a coefficient C(t). FIGS. 13A to 13D illustrate temporal traces of processed cross-sectional shapes. FIG. 14 illustrates temporal changes in depth positions of the frontage portion 203, the upper stage of bowing portion 202-1, and the lower stage of bowing portion 202-2.

The shape function includes a coefficient depending on an etching time, and can indicate a change in shape in accordance with the etching time.

For example, in FIG. 10, the shape function S₁(x) corresponding to the upper stage of bowing portion 202-1 includes a coefficient C₁(t) depending on the etching time. When the coefficient C₁(t) is plotted and graphed with time t on the horizontal axis and a coefficient value on the vertical axis, the coefficient C₁(t) changes approximately along a straight line as illustrated in FIG. 12. FIG. 12 illustrates a temporal change of a coefficient. The inclination of the graph of the coefficient C₁(t) indicates an etching rate of the first ion. That is, when the etching rate of the first ion is defined as ER₁ and the etching time is defined as t, the coefficient C₁(t) is expressed by the Expression 12 below. The etching rate ER₁ is a constant that does not depend on the time t.

$${\text{C}}_{1} \left(\text{t}\right) = {\text{ER}}_{1} \times \text{t} \qquad \text{Expression 12}$$

The shape function S₂(x) corresponding to the lower stage of bowing portion 202-2 includes a coefficient C₂(t) depending on the etching time. When the coefficient C₂(t) is plotted and graphed with time t on the horizontal axis and a coefficient value on the vertical axis, the coefficient C₂(t) changes approximately along a straight line as illustrated in FIG. 12. The inclination of the graph of the coefficient C₂(t) indicates an etching rate of the second ion. That is, when the etching rate of the second ion is defined as ER₂ and the etching time is defined as t, the coefficient C₂(t) is expressed by the Expression 13 below. The etching rate ER₂ is a constant that does not depend on the time t.

$${\text{C}}_{2} \left(\text{t}\right) = {\text{ER}}_{2} \times \text{t} \qquad \text{Expression 13}$$

When a graph is created by substituting Expressions 12 and 13 into the expression in FIG. 10, substituting t = t₂₁ into the expression, using x = AR as a vertical axis, and using the ion flux amount Γ_{ion,SIDE} as a horizontal axis, the graph is indicated by a dotted line in FIG. 13A. The processed cross-sectional shape predicted by the addition of shape functions fits well to a result of performing SEM observation on the processed cross section at an actual time t₂₁ indicated by a solid line in FIG. 13A.

When a graph is created by substituting Expressions 12 and 13 into the expression in FIG. 10, substituting t = t₂₂ (> t₂₁) into the expression, using x = AR as a vertical axis, and using the ion flux amount Γ_{ion,SIDE} as a horizontal axis, the graph is indicated by a dotted line in FIG. 13B. The processed cross-sectional shape predicted by the addition of shape functions fits well to a result of performing SEM observation on the processed cross section at an actual time t₂₂ indicated by a solid line in FIG. 13B.

When a graph is created by substituting Expressions 12 and 13 into the expression in FIG. 10, substituting t = t₂₃ (> t₂₂) into the expression, using x = AR as a vertical axis, and using the ion flux amount Γ_{ion,SIDE} as a horizontal axis, the graph is indicated by a dotted line in FIG. 13C. The processed cross-sectional shape predicted by the addition of shape functions fits well to a result of performing SEM observation on the processed cross section at an actual time t₂₃ indicated by a solid line in FIG. 13C.

When a graph is created by substituting Expressions 12 and 13 into the expression in FIG. 10, substituting t = t₂₄ (> t₂₃) into the expression, using x = AR as a vertical axis, and using the ion flux amount Γ_{ion,SIDE} as a horizontal axis, the graph is indicated by a dotted line in FIG. 13D. The processed cross-sectional shape predicted by the addition of shape functions fits well to a result of performing SEM observation on the processed cross section at an actual time t₂₄ indicated by a solid line in FIG. 13D.

If the processed cross-sectional shapes indicated by dotted lines are seen in the order of FIG. 13A, FIG. 13B, FIG. 13C, and FIG. 13D, a temporal change of the processed cross-sectional shape by the addition of shape functions can be traced. This allows temporal trace of the processed cross-sectional shape without destruction. The temporal tracing takes a lot of time in process development.

For example, as illustrated in FIG. 14, a temporal change of a predetermined portion of the cross-sectional processed shape can be confirmed. FIG. 14 illustrates temporal changes in depth positions of the frontage portion 203, the upper stage of bowing portion 202-1, and the lower stage of bowing portion 202-2. When the depth position (aspect ratio AR₂₀₃) of the frontage portion 203 is plotted and graphed with time t on the horizontal axis and the depth position on the vertical axis, the depth position of the frontage portion 203 changes approximately along a straight line as illustrated in FIG. 14. Similarly, when the depth position (aspect ratio AR₁₁) of the upper stage of bowing portion 202-1 is plotted and graphed with time t on the horizontal axis and the depth position on the vertical axis, the depth position of the upper stage of bowing portion 202-1 changes approximately along a straight line as illustrated in FIG. 14. When the depth position (aspect ratio AR₁₂) of the bowing portion 202-2 is plotted and graphed with time t on the horizontal axis and the depth position on the vertical axis, the depth position of the lower stage of bowing portion 202-2 changes approximately along a straight line as illustrated in FIG. 14.

That is, since the temporal change of the cross-sectional processed shape can be confirmed by tracing the temporal change of the same or similar parameter, the number of parameters used for the temporal trace of the processed cross-sectional shape can be reduced, and processing of the temporal trace of the processed cross-sectional shape can be made efficient.

As described above, in the embodiment, the inspection device 1 reconstructs a processed cross-sectional shape by using a shape function in a case where the degree of coincidence between the actually measured spectral pattern PT1 and the spectral pattern PT2 determined from the shape function is adjusted to be equal to or greater than a threshold. As a shape function, a function, which indicates an ion flux amount in accordance with an etching depth at the time when a predetermined pattern (e.g., hole pattern 200) is processed in dry etching processing and includes ion incident angle distribution based on a velocity distribution function, is used. The shape function may include the ion incident angle distribution based on an addition of plural different velocity distribution functions. This allows reconstruction of a processed cross-sectional shape using a shape function expressing a processed cross-sectional shape based on a physical model. A change of a cross-sectional processed shape due to a change of a process condition and the like can be flexibly addressed, and robustness of inspection performed by the inspection device 1 can be easily improved.

For example, a case where the processed cross-sectional shape is approximated by a general polynomial will be considered. The general polynomial is obtained by adding plural values obtained by exponentiating a variable by a predetermined order and multiplying the exponentiated variable by a predetermined coefficient. In the general polynomial, the order and the coefficient are constant numbers. In this case, a processed cross-sectional shape is reconstructed by setting an initial parameter in the general polynomial, determining a spectral pattern PT2′ from a shape represented by the general polynomial, and adjusting a parameter to be applied to the general polynomial so that an actually measured spectral pattern PT1′ and the spectral pattern PT2′ coincide with each other. When the actually measured spectral pattern PT1′ and the spectral pattern PT2′ in accordance with the general polynomial coincide with each other, the shape represented by the general polynomial may deviate from the actual processed cross-sectional shape due to an inappropriate initial parameter. That is, the prediction accuracy of the processed cross-sectional shape represented by the general polynomial easily varies depending on whether or not an initial parameter to be applied is appropriate or inappropriate.

In contrast, in the embodiment, as a shape function, a function, which indicates an ion flux amount in accordance with an etching depth at the time when a predetermined pattern (e.g., hole pattern 200) is processed in dry etching processing and includes ion incident angle distribution based on a velocity distribution function, is used. This allows reconstruction of a processed cross-sectional shape using a shape function expressing a processed cross-sectional shape based on a physical model. A change of a cross-sectional processed shape due to a change of a process condition and the like can be flexibly addressed, and robustness of inspection performed by the inspection device 1 can be easily improved.

For example, when the processed cross-sectional shape is approximated by the general polynomial and the temporal change of the processed cross-sectional shape is traced, m (m is integer larger than 3) steps of time to be traced are provided. For example, in the first step, 10 parameters are applied to a general polynomial to predict a processed cross-sectional shape, and the processed cross-sectional shape is fitted to an actual processed cross-sectional shape subjected to cross-sectional SEM observation. In the second step, other 10 parameters are applied to a general polynomial to predict a processed cross-sectional shape, and the processed cross-sectional shape is fitted to an actual processed cross-sectional shape subjected to cross-sectional SEM observation. In the m-th step, still other 10 parameters are applied to a general polynomial to predict a processed cross-sectional shape, and the processed cross-sectional shape is fitted to an actual processed cross-sectional shape subjected to cross-sectional SEM observation. The total number of parameters used for tracing the temporal change of the processed cross-sectional shape is 10 × m. That is, a processing load may increase as the number of steps of time to be traced increases.

In contrast, in the embodiment, the temporal change of the cross-sectional processed shape can be confirmed by tracing the temporal change of the same or similar parameter. For example, although m steps of time to be traced are provided, a common parameter is used in each step. When two parameters are provided for an origin position, one parameter is provided for an index, and one parameter is provided for a bow width, these parameters are doubled for two stages, and three parameters are provided for a bottom position and inclination, the total number of parameters used for tracing the temporal change of the processed cross-sectional shape is represented as (2 + 1 + 1) × 2 + 3 = 11. That is, the number of parameters used for the temporal trace of the processed cross-sectional shape can be reduced, and processing of the temporal trace of the processed cross-sectional shape can be made efficient.

Note that, although FIGS. 9 and 10 illustrate a case where a shape function is based on an addition of plural Maxwell velocity distribution functions, the shape function may include another velocity distribution function in addition to or instead of the Maxwell velocity distribution functions. For example, a possible velocity distribution function applicable to the shape function includes normal distribution, exponential distribution, distribution in accordance with a trigonometric function such as sin, cos, and tan, power distribution, a uniform distribution, and distribution functions obtained by four arithmetic operation and convolution thereto. That is, the shape function may include ion incident angle distribution based on an addition of a Maxwell velocity distribution function and another velocity distribution function. Alternatively, the shape function may include ion incident angle distribution based on an addition of a first velocity distribution function different from the Maxwell velocity distribution function and a second velocity distribution function different from the Maxwell velocity distribution function. The first velocity distribution function and the second velocity distribution function may be different from each other.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inspection device comprising:
a measurement unit that measures a physical quantity in accordance with a predetermined pattern for a sample with the predetermined pattern, and generates a first spectral pattern in accordance with a measurement result; and
a controller that predicts a processed cross-sectional shape by applying a parameter to a shape function indicating an ion flux amount in accordance with an etching depth in a case where the predetermined pattern is processed in dry etching processing, determines a second spectral pattern in accordance with the processed cross-sectional shape that has been predicted, adjusts the parameter while comparing the first spectral pattern with the second spectral pattern, and reconstructs the processed cross-sectional shape of the sample in accordance with an adjustment result.

2. The inspection device according to claim 1,
wherein the predetermined pattern includes a hole pattern, and
the shape function is obtained by integrating an amount of ion fluxes in a depth direction, the ion fluxes incident on a sidewall of the hole pattern in accordance with an etching depth.

3. The inspection device according to claim 1,
wherein the shape function includes ion incident angle distribution based on a velocity distribution function.

4. The inspection device according to claim 1,
wherein the shape function includes ion incident angle distribution based on an addition of plural different velocity distribution functions.

5. The inspection device according to claim 3,
wherein, when a divergence angle of ions is defined as θ and a parameter indicating a degree of divergence of ions is defined as n, the shape function includes cosⁿ⁺²θ.

6. The inspection device according to claim 1,
wherein the shape function is a solution of an algebraic equation including, in order, a parameter indicating a degree of divergence of ions.

7. The inspection device according to claim 1,
wherein the shape function further indicates a change in shape in accordance with an etching time.

8. The inspection device according to claim 7,
wherein the shape function further includes a coefficient depending on the etching time.

9. The inspection device according to claim 8,
wherein the coefficient includes an amount obtained by multiplying an etching rate by time.

10. The inspection device according to claim 1,
wherein the measurement unit measures radiation diffracted by the sample at a time when radiation is applied to the sample, and generates the first spectral pattern in accordance with a measurement result.

11. An inspection method comprising:
measuring a physical quantity in accordance with a predetermined pattern for a sample with the predetermined pattern;
generating a first spectral pattern in accordance with a result that has been measured;
predicting a processed cross-sectional shape by applying a parameter to a shape function indicating an ion flux amount in accordance with an etching depth in a case where the predetermined pattern is processed in dry etching processing;
determining a second spectral pattern in accordance with the processed cross-sectional shape that has been predicted;
adjusting the parameter while comparing the first spectral pattern with the second spectral pattern; and
reconstructing the processed cross-sectional shape of the sample in accordance with a result that has been adjusted.

12. The inspection method according to claim 11,
wherein the predetermined pattern includes a hole pattern, and
the shape function is obtained by integrating an amount of ion fluxes in a depth direction, the ion fluxes incident on a sidewall of the hole pattern in accordance with an etching depth.

13. The inspection method according to claim 11,
wherein the shape function includes ion incident angle distribution based on a velocity distribution function.

14. The inspection method according to claim 11,
wherein the shape function includes ion incident angle distribution based on an addition of plural different velocity distribution functions.

15. The inspection method according to claim 13,
wherein, when a divergence angle of ions is defined as θ and a parameter indicating a degree of divergence of ions is defined as n, the ion flux amount includes cosⁿ⁺²θ.

16. The inspection method according to claim 11,
wherein the shape function is a solution of an algebraic equation including, in order, a parameter indicating a degree of divergence of ions.

17. The inspection method according to claim 11,
wherein the shape function further indicates a change in shape in accordance with an etching time.

18. The inspection method according to claim 17,
wherein the shape function further includes a coefficient depending on the etching time.

19. The inspection method according to claim 18,
wherein the coefficient includes an amount obtained by multiplying an etching rate by time.

20. The inspection method according to claim 11,
wherein the measuring includes measuring radiation diffracted by the sample at a time when radiation is applied to the sample.
